(19) United States
(12) Patent Application Publication
(10) Pub. No.: US 2025/0335684 A1
(43) Pub. Date: Oct. 30, 2025

(54) METHOD OF CIRCUIT SIMULATION

(71) Applicant: Yu Tian, Surrey (CA)

(72) Inventor: Yu Tian, Surrey (CA)

(21) Appl. No.: 19/260,419

(22) Filed: Jul. 4, 2025

(30) Foreign Application Priority Data
Apr. 18, 2025 (CN) 202510486487.7

(51) Int. Cl. G06F 30/367

(52) U.S. Cl. CPC G06F 30/367

(57) ABSTRACT

A circuit simulation method partitions circuits into linear and nonlinear subcircuits, obtains frequency responses of the linear portion, and applies causality-enforcing corrections to eliminate non-physical artifacts from band-limited data. The corrected responses enable construction of equivalent circuit models using voltage/current sources with passive elements, where source values update via convolution with port histories. This approach improves simulation accuracy and stability compared to direct frequency-inverse methods while maintaining compatibility with standard platforms including SPICE, PSCAD, and Simulink. Applications include power system transients, RF circuits, and high-speed digital interfaces.

### CROSS-REFERENCE TO RELATED APPLICATIONS

This application claims priority under 35 U.S.C. § 119(a) to Chinese Patent Application No. 202510486487.7, filed on 18 Apr. 2025, the entire disclosure of which is incorporated herein by reference.

### BACKGROUND OF THE INVENTION

### Field

This disclosure relates to the field of circuit system modeling and simulation technology, and more particularly, to a method for establishing equivalent models to implement circuit simulation, a computer-readable storage medium, and a circuit simulation apparatus.

### Description of Related Art

Circuit simulation is a core analytical technique that uses mathematical models and numerical methods to predict the electrical behaviour of circuits under various operating conditions. Depending on the data representation and solution strategy employed, simulation workflows are generally divided into frequency-domain and time-domain categories. Time-domain analysis, which solves for node voltages and branch currents as explicit functions of time, is indispensable in power-system dynamics, radio-frequency (RF) chain modelling, and high-speed digital-link verification.

Mainstream modelling approaches construct equivalent networks of resistors, inductors, capacitors, controlled sources, and behavioural elements, then apply nodal or state-space techniques to perform the time-domain solution. Such methods, widely integrated in SPICE and derivative tools, underpin most contemporary engineering studies. However, where circuit structures are complex, exhibit abrupt frequency characteristics, or display strong dynamic coupling, these approaches often suffer from reduced accuracy, numerical-stability issues, and interface-coupling difficulties. Convergence failures, simulation divergence, and distorted results are frequently observed in power-system transients, large-scale RF module chains, and high-speed interconnect scenarios. In addition, conventional techniques cannot directly reuse measured or pre-computed frequency-response data and therefore fail to exploit valuable prior information that could improve both fidelity and efficiency.

An alternative line of research adopts convolution of stored impulse or frequency responses with input-port signals to predict output behaviour without forming an explicit circuit model. While numerically straightforward, the absence of a structured equivalent network and standardized port interfaces hampers topological combination with other system modules, limiting re-usability and practical deployment.

Moreover, many existing solutions are closely tied to particular simulation engines or interface standards, making seamless embedding into heterogeneous environments—such as SPICE, Simulink, PSCAD, and RTDS—difficult and time-consuming, thereby reducing engineering portability and integration efficiency.

### RELATED ART REFERENCES

Chinese Patent No. CN 106326509 B, Canadian Patent Nos. CA 2988865 and CA 3108477, and U.S. Pat. No. 10,445,448 B2 are cited herein solely for their discussion of background circuit-modelling techniques. These documents are incorporated by reference for background information only, and no portion of any of them is admitted to be prior art with respect to the present disclosure.

### SUMMARY OF THE INVENTION

This disclosure provides a circuit modeling and simulation method based on response correction that addresses deficiencies in existing modeling techniques, including lack of response causality, non-combinable structures, insufficient modeling accuracy, and poor platform compatibility. The method performs causality correction on frequency responses and constructs well-defined equivalent circuit models to achieve module substitution modeling and system combination simulation across multiple simulation platforms, suitable for high-accuracy time-domain analysis in complex scenarios including electronic systems, power electronic systems, and power systems.

The method comprises the following core steps: partitioning a circuit to be simulated into a subcircuit-1 and a subcircuit-2, where the subcircuit-1 is a linear, time-invariant subcircuit; obtaining frequency responses of the subcircuit-1 at a set of discrete frequency points; performing causality correction processing on the frequency response data through techniques such as Hilbert transform, mirror-symmetric superposition, or magnitude-weighted correction to construct a complete complex spectrum satisfying system physical causality characteristics; converting the corrected spectral data to a system time-domain response function through inverse Fourier transform; and constructing an equivalent circuit structure comprising a voltage source in series with a resistor or a current source in parallel with a conductor using the obtained time-domain response, which is then connected to the subcircuit-2 at the port to form a combined circuit for system-level simulation.

The method is applicable to multiple high-accuracy modeling and simulation scenarios, including but not limited to: power system transient simulation (such as modeling interface behavior of transmission lines, transformers, converters, and power grids), electronic circuit simulation (such as high-speed signal channels and analog front-end modules), RF system modeling and dynamic characteristic evaluation, and module-level modeling and system-level verification in integrated circuits.

To enhance engineering applicability, the equivalent circuit models disclosed herein possess excellent platform portability. The equivalent circuit models can be embedded in a wide range of simulation platforms—covering SPICE-compatible, electromagnetic-transient, real-time, and system-level environments—without architectural changes.

Compared to the applicant's previously proposed and granted modeling solutions (such as Chinese Patent CN106326509B, Canadian Patents CA2988865 and CA3108477, and U.S. Pat. No. 10,445,448B2), the proposed technique introduces a causality correction step for frequency responses in the modeling process, effectively eliminating non-physical components resulting from response truncation, thereby substantially improving time-domain response accuracy and modeling stability. Additionally, the proposed equivalent modeling structure provides superior port combination capability suitable for integration into system-level modeling frameworks.

Compared to existing numerical solutions that only generate outputs through impulse response or frequency response convolution, the disclosed method not only provides a response correction mechanism but also constructs circuit models with well-defined structures and accessible ports, possessing topological expression capability and module reusability, suitable for flexible configuration and simulation integration in multi-module systems.

The disclosed embodiments provide several notable technical advantages. Through causality correction of frequency responses, the method obtains physically consistent time-domain responses, thereby eliminating mirror artefacts and enhancing modelling accuracy as well as numerical stability. The ensuing equivalent circuit models possess a clear topology and adjustable parameters, enabling seamless combination with other modules for system-level simulation. In addition, an integrated workflow—covering circuit partitioning, response acquisition, spectral correction and structural modelling—allows straightforward migration to mainstream or proprietary simulation platforms without architectural alteration. Finally, the availability of multiple correction strategies accommodates different data forms and precision requirements, further extending the method's engineering applicability.

In summary, the proposed method addresses deficiencies in existing solutions regarding accuracy control, response consistency, model integration, and platform adaptation by providing a structured, combinable, cross-platform circuit modeling and simulation solution with significant technical advancement and industrial application value.

### BRIEF DESCRIPTION OF DRAWINGS

FIG. 1 is a flowchart illustrating one embodiment of the circuit-simulation method disclosed herein.

FIG. 2 shows circuit partitioning of a target circuit into subcircuit-1 and subcircuit-2.

FIG. 3 shows an equivalent circuit formed when subcircuit-1 is modeled as a voltage source in series with a resistor and combined with subcircuit-2.

FIG. 4 shows an equivalent circuit formed when subcircuit-1 is modeled as a current source in parallel with a conductor and combined with subcircuit-2.

FIG. 5 is a block diagram of simulation-function modules used in the method.

FIG. 6 is a schematic diagram of a computer system suitable for implementing the method.

### DETAILED DESCRIPTION OF THE INVENTION

The following provides specific embodiments of the circuit simulation method proposed by this disclosure to further illustrate the technical principles of this disclosure. It should be understood that the following embodiments are merely illustrative and are not intended to limit the scope of protection of this disclosure.

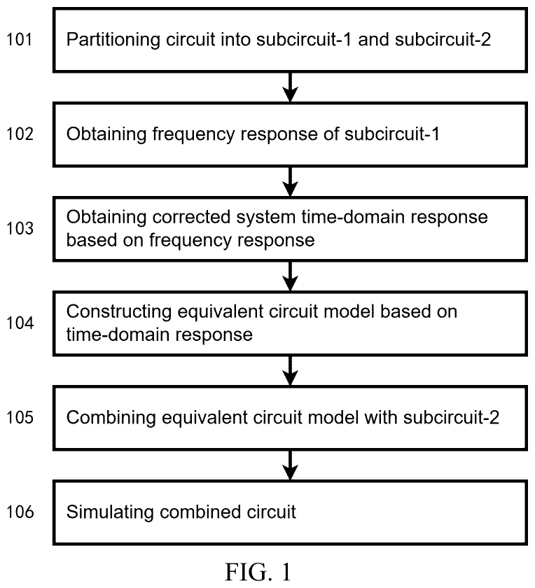

As shown in FIG. 1, this disclosure provides a circuit simulation method comprising the following steps:

### Step 101: Circuit Partitioning

The circuit to be simulated refers to the complete target circuit serving as the simulation object, which typically contains multiple sub-modules or functional units with potentially complex structures that are difficult to model as a whole or result in low simulation efficiency. In practical engineering, this circuit can be described through netlist files (such as SPICE format), hardware description languages, data files generated by structural modeling platforms, or other means, containing device information, network connection relationships, and other content that can serve as input for subsequent modeling processes.

To improve simulation efficiency and model flexibility, this disclosure partitions the circuit to be simulated into two portions, referred to as subcircuit-1 and subcircuit-2, respectively. Subcircuit-1 is the subcircuit to be replaced by modeling, whose behavior will be described through an algorithmic model conforming to a fixed response; subcircuit-2 comprises the remaining circuits that retain their original structure and directly participate in system simulation.

After partitioning is completed, one or more logical ports will be formed between subcircuit-1 and subcircuit-2, serving to connect the model interface with physical quantities of the actual circuit. These ports are essentially voltage and current interaction interfaces determined after the partitioning operation to facilitate model integration, rather than inherent structures of the circuit to be simulated itself.

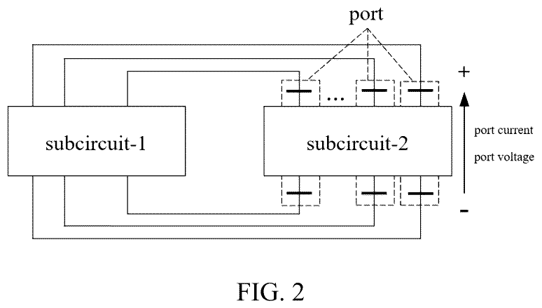

FIG. 2 illustrates the structure after circuit partitioning, where the left side represents subcircuit-1 and the right side represents subcircuit-2, with the two interconnected through connection ports.

Preferably, subcircuit-1 should be selected as a linear time-invariant circuit. Such circuits have input-output relationships that satisfy linear superposition and time invariance, making them suitable for behavioral description using frequency responses or time-domain responses, and facilitating the establishment of interfaceable substitution models.

If subcircuit-1 contains nonlinear elements (such as magnetically saturated transformer cores) or time-varying elements (such as switching elements in power systems), it is generally not suitable for accurate algorithmic substitution using this method.

This disclosure imposes no restrictions on circuit partitioning strategies, which can be flexibly determined according to engineering requirements. For example, in power system applications, network-side circuits can serve as subcircuit-1, while controllers, converters, forward-reverse processing units, and other circuits connected thereto serve as subcircuit-2; in integrated circuit applications, interconnects or high-speed buses can serve as subcircuit-1, with other functional modules as subcircuit-2, establishing an overall simulation structure.

### Step 102: Obtaining Frequency Response

After completing circuit partitioning, the frequency response of subcircuit-1 must be obtained to provide a basis for subsequent equivalent modeling. The frequency response referred to in this disclosure specifically denotes the frequency-domain transfer characteristics obtained by applying excitation and observing the response at the port, specifically including: frequency response with port current as input and voltage as output, or frequency response with port voltage as input and current as output. This form of response is used to characterize the causal relationship between voltage and current at the port terminals, serving as the foundation for constructing modeling structures of a voltage source in series with a resistor or a current source in parallel with a conductor.

Depending on the construction form of the subsequent equivalent circuit model, the input-output definitions of the required frequency response also differ. If a modeling approach using a voltage source in series with a resistor is to be adopted in Step 104, then the frequency response with port current as input and voltage as output—that is, the complex impedance Z(ω)=V(ω)/I(ω)—should be obtained; whereas if a modeling approach using a current source in parallel with a conductor is adopted, then the frequency response with port voltage as input and current as output—namely, the complex admittance Y(ω)=I(ω)/V(ω)—should be obtained. Although these two constitute mutually dual descriptions from a signal processing perspective, their modeling input variables differ, and therefore the direction of the required frequency-domain data should be consistent with the selected modeling approach.

The frequency response employed in this disclosure is typically represented by complex response values at predetermined discrete frequency points, facilitating storage and processing in computers. The selection of discrete frequencies should cover the main operating frequency band of the target system, and the density of frequency sampling should satisfy the sampling theorem and actual modeling accuracy requirements to avoid numerical leakage or distortion.

For linear subcircuits with known structures, their frequency responses can be calculated through symbolic analysis, AC small-signal simulation, or frequency sweeping methods. For black-box modules with unknown structures or unbehaviorable characteristics, frequency response data can also be obtained through frequency-domain testing or port data extraction. In some engineering applications, response data may also originate from third-party simulation platforms or measured data files.

The accuracy of the frequency response directly determines the physical reliability of the response function in the subsequent model. To ensure the accuracy of equivalent modeling, measurement errors or numerical artifacts should be minimized when obtaining frequency response data, and it should be ensured that the response possesses physical consistency and sufficient frequency-domain bandwidth.

### Step 103: Obtaining Corrected System Time-Domain Response

Since frequency responses are typically obtained through discrete sampling at a finite number of frequency points (e.g., 0 Hz to 10 kHz with 1024 linearly-spaced points), directly performing inverse Fourier transform (IFFT) on such band-limited data often results in non-ideal time-domain behavior. This spectral truncation introduces artifacts such as ripples and oscillations in the time domain, commonly known as the “Gibbs phenomenon.” Additionally, when the sampled frequency response lacks certain spectral components or exhibits asymmetry, the resulting time-domain response may violate system causality—manifesting as non-zero values for negative time, which is physically impossible for real systems. These causality violations not only compromise the physical validity of the model but also lead to numerical instability during time-domain simulation, potentially causing convergence failures or erroneous results.

To address these fundamental issues, this disclosure introduces a series of correction methods based on the mathematical relationships inherent in causal systems. These methods leverage principles such as the Kramers-Kronig relations and the properties of analytic signals to reconstruct physically consistent time-domain responses from potentially incomplete or imperfect frequency-domain data.

In the implementations described herein, the time-domain response is represented as a discrete sequence of length N, where:
the element at index 0 corresponds to time t=0;
elements at indices 1 through N/2 represent positive time samples (t>0); and
elements at indices N/2+1 through N−1 represent negative time samples (t<0).

For a causal system, the negative time portion must be zero, as the system cannot respond before an excitation is applied. The correction methods presented below ensure this causality constraint while preserving the accuracy of the system's frequency-domain characteristics.

The fundamental principle underlying these corrections is that for any linear, time-invariant, causal system, specific mathematical relationships must exist between different components of the frequency response. By enforcing these relationships, we can reconstruct a complete, causal response even from partial or imperfect frequency-domain measurements.

The following subsections enumerate various time-domain response correction methods that can be employed in this disclosure. Each method is designed to address specific scenarios and data characteristics while ensuring the resulting time-domain response satisfies causality requirements.

### Correction Method 1: Reconstructing Imaginary Part From Real Part

This method constructs a complete causal frequency response by generating the imaginary part from the real part data. The procedure consists of the following steps:
1. Extract the real part Re{H(ω)} from the measured or computed frequency-domain response of subcircuit-1.
2. Apply the Hilbert transform to the real part to generate the corresponding imaginary part:

$$Im \{ H ( ω ) \} = - H [ Re \{ H ( ω ) \} ]$$

where H denotes the Hilbert transform operator.
3. Combine the real part and the generated imaginary part to form a complete

complex frequency-domain response:

$$H ( ω ) = Re \{ H ( ω ) \} + j \cdot Im \{ H ( ω ) \}$$

4. Perform inverse Fourier transform on the complete complex frequency-domain response to obtain the causal time-domain response sequence h[n].

By reconstructing the imaginary part through the Hilbert transform, the method ensures that the resulting frequency response corresponds to a causal time-domain function.

### Correction Method 2: Weighting and Truncation After Real Part Inverse Transform

This method obtains a causal time-domain response by directly processing the real part of the frequency response. The procedure consists of the following steps:
1. Extract the real part Re{H(ω)} from the frequency-domain response.
2. Perform inverse Fourier transform on the real part to obtain an initial time-domain response sequence x[n].
3. Multiply the positive-time portion of the response by a predetermined factor a (typically α=2):
For t>0: y[n]=α·x[n]
For t=0: y[0]=x[0] (preserve the value at time zero)
For t<0: y[n]=0 (enforce causality)
4. The resulting sequence y[n] is the causal time-domain response.

The multiplication factor compensates for the energy that would have been

present in the negative-time portion of a non-causal response. The preservation of the value at time zero ensures that the DC component of the frequency response remains unchanged, maintaining consistency with the original frequency-domain data.

### Correction Method 3: Symmetric Point Superposition Processing

This method constructs a causal time-domain response by combining values from symmetric points in the initial time-domain sequence. The procedure consists of the following steps:
1. Perform inverse Fourier transform on the complete frequency-domain response H(ω) to obtain an initial time-domain sequence x[n].
2. For each positive-time instant, add the value at that instant to the value at its corresponding negative-time instant. For a discrete sequence x[n] of length N:
For n=1, 2, . . . , N/2−1: y[n]=x[n]+x[N−n]
For n=0: y[0]=x[0] (preserve the value at time zero)
For n=N/2, . . . , N−1: y[n]=0 (set negative-time portion to zero)
3. The resulting sequence y[n] is the causal time-domain response.

This method effectively folds the negative-time energy into the positive-time portion while maintaining causality. The superposition operation preserves the even-symmetric components of the response while properly accounting for the odd-symmetric components. By preserving the value at time zero, the method ensures that the DC component of the original frequency response remains unchanged.

### Correction Method 4: Reconstructing Real Part From Imaginary Part

This method constructs a complete causal frequency response by generating the real part from the imaginary part data. The procedure consists of the following steps:
1. Extract the imaginary part Im{H(ω)} from the measured or computed frequency-domain response of subcircuit-1.
2. Apply the Hilbert transform to the imaginary part to generate the corresponding real part:

$$Re \{ H ( ω ) \} = H [ Im \{ H ( ω ) \} ]$$

where H denotes the Hilbert transform operator.
3. Combine the generated real part and the original imaginary part to form a complete complex frequency-domain response:

$$H ( ω ) = Re \{ H ( ω ) \} + j \cdot Im \{ H ( ω ) \}$$

4. Perform inverse Fourier transform on the complete complex frequency-domain response to obtain an initial time-domain response h[n].
5. Assign the average value of the original frequency-domain response to the value at time zero:

$$h [ 0 ] = ( 1 / N ) \cdot \sum H ( ω k )$$

where the sum is taken over all frequency points.

The final step of assigning the average value ensures proper DC component reconstruction.

### Correction Method 5: Weighting and Truncation After Imaginary Part Inverse Transform

This method obtains a causal time-domain response by directly processing the imaginary part of the frequency response. The procedure consists of the following steps:
1. Extract the imaginary part Im{H(ω)} from the frequency-domain response.
2. Perform inverse Fourier transform on the imaginary part to obtain an initial time-domain response sequence x[n].
3. Multiply the positive-time portion of the response by a predetermined factor a (typically α=2) and enforce causality:
For n=1, 2, . . . , N/2−1: y[n]=α·x[n]
For n=N/2, . . . , N−1: y[n]=0 (enforce causality)
4. Assign the average value of the original frequency-domain response to the value at time zero:

$$y [ 0 ] = ( 1 / N ) \cdot \sum H ( ω k )$$

5. The resulting sequence y[n] is the causal time-domain response.

Similar to Method 2, the multiplication factor compensates for the energy in the negative-time portion. The assignment of the average value at time zero ensures proper DC component handling, which is particularly important when starting from the imaginary part alone.

### Correction Method 6: Symmetric Point Difference Processing

This method constructs a causal time-domain response by taking differences

between symmetric points in the initial time-domain sequence. The procedure consists of the following steps:
1. Perform inverse Fourier transform on the complete frequency-domain response H(ω) to obtain an initial time-domain sequence x[n].
2. For each positive-time instant, subtract the value at the corresponding negative-time instant from the value at that instant. For a discrete sequence x[n] of length N:
For n=1, 2, . . . , N/2−1: y[n]=x[n]−x[N−n]
For n=0: y[0]=x[0] (preserve the value at time zero)
For n=N/2, . . . , N−1: y[n]=0 (set negative-time portion to zero)
3. The resulting sequence y[n] is the causal time-domain response.

This method effectively extracts the odd-symmetric components of the response while canceling the even-symmetric components that would violate causality. By preserving the value at time zero, the method maintains the DC component of the original frequency response.

### Correction Method 7: Reconstructing Phase From Logarithmic Magnitude

This method constructs a minimum-phase frequency response by generating the phase from the logarithmic magnitude data. The procedure consists of the following steps:
1. Extract the magnitude |H(ω)| from the frequency-domain response.
2. Take the natural logarithm of the magnitude to obtain the logarithmic magnitude:

$$ln \vert H ( ω ) \vert = ln ( \vert H ( ω ) \vert )$$

3. Apply the Hilbert transform to the logarithmic magnitude to generate the corresponding phase:

$$φ ( ω ) = - H [ ln \vert H ( ω ) \vert ]$$

where H denotes the Hilbert transform operator.
4. Combine the original magnitude with the generated phase to form a minimum-phase frequency-domain response:

$$H ( ω ) = \vert H ( ω ) \vert \cdot exp ( j \cdot φ ( ω ) )$$

5. Perform inverse Fourier transform on the minimum-phase frequency-domain response to obtain the causal time-domain response h[n].

This method is particularly suitable for systems known to exhibit minimum-phase characteristics, where a unique relationship exists between the logarithmic magnitude and phase. The resulting response is guaranteed to be both causal and stable, making it ideal for applications requiring these properties.

### Correction Method 8: Reconstructing Logarithmic Magnitude From Phase

This method constructs a frequency response by generating the magnitude from the phase information. The procedure consists of the following steps:
1. Extract the phase φ(ω) from the frequency-domain response.
2. Apply the Hilbert transform to the phase to generate the corresponding logarithmic magnitude:

$$ln \vert H ( ω ) \vert = H [ φ ( ω ) ]$$

where H denotes the Hilbert transform operator.
3. Convert the logarithmic magnitude to linear magnitude through exponentiation:

$$\vert H ( ω ) \vert = exp ( ln \vert H ( ω ) \vert )$$

4. Combine the generated magnitude with the original phase to form a complete frequency-domain response:

$$H ( ω ) = \vert H ( ω ) \vert \cdot exp ( j \cdot φ ( ω ) )$$

5. Perform inverse Fourier transform on the frequency-domain response to obtain an initial time-domain response h[n].
6. Assign the average value of the original frequency-domain response to the value at time zero:

$$h [ 0 ] = ( 1 / N ) \cdot \sum H ( ω k )$$

where the sum is taken over all frequency points.

This method is useful when phase information is more reliable than magnitude data, or when constructing a system response with specific phase characteristics. The final step ensures proper DC component reconstruction when the magnitude is synthesized from phase information alone.

### Relationships Among Correction Methods

In practical implementation, Correction Methods 1, 2, and 3 achieve equivalent results through different computational paths. For a causal linear time-invariant system, the real and imaginary parts of its frequency response are related through the Hilbert transform, manifesting as even-symmetric and odd-symmetric components in the time domain, respectively. Since a causal system's response must be zero for negative time, proper superposition or scaling of the positive-time portion can reconstruct the complete causal response. Method 1 enforces this relationship in the frequency domain through Hilbert transform reconstruction, Method 2 applies direct scaling in the time domain, and Method 3 achieves the same result through symmetric point addition.

Similarly, Correction Methods 4, 5, and 6 form a complementary set of approaches starting from the imaginary part of the frequency response. These methods parallel Methods 1, 2, and 3 respectively, but operate on the imaginary component, which corresponds to the odd-symmetric part of the time-domain response. The additional step of assigning the average frequency-domain value at time zero in Methods 4 and 5 compensates for the loss of DC information when starting from the imaginary part alone.

Correction Methods 7 and 8 operate on a different principle, exploiting the relationship between logarithmic magnitude and phase for minimum-phase systems. In such systems, the Kramers-Kronig relations establish a unique mapping between these quantities, enabling complete reconstruction from partial information. These methods are particularly valuable when the system is known to be minimum-phase, as they guarantee both causality and stability. However, for non-minimum-phase systems, these methods may introduce deviations and should be applied with appropriate validation.

The selection among these correction methods should be guided by the nature of the available frequency-domain data, the known characteristics of the system, and the specific accuracy requirements of the application. This disclosure encompasses all methods capable of producing causal time-domain responses from frequency-domain data, regardless of the specific mathematical approach employed.

In some embodiments, one or more correction methods described herein may be applied sequentially, iteratively, or in combination. For example, different correction techniques—such as real-part reconstruction, imaginary-part extension, symmetry-based synthesis, or log-magnitude and phase reconstruction—may be selectively combined depending on the characteristics of the frequency-domain data. These correction methods can also be applied in multiple stages, including iterative schemes in which the corrected time-domain response is refined over successive passes. The sequence, frequency, or combination strategy of such corrections is not limited to any particular order or number of applications, and may be configured dynamically based on desired accuracy, causality quality, or simulation stability.

### Implementation Considerations

In practical implementations, sign conventions may vary depending on the specific definition of the Hilbert transform or the FFT algorithm employed. Some implementations may require a sign reversal (multiplication by −1) to achieve the correct phase relationships. Additionally, the weighting factor a in Methods 2 and 5 may take negative values (e.g., −2) when processing certain types of data to maintain proper causality structure. These implementation-specific adjustments are considered equivalent variations within the scope of this disclosure.

The flexibility to adjust signs and scaling factors ensures compatibility across different computational platforms and signal processing frameworks while maintaining the fundamental principle of constructing physically realizable, causal time-domain responses from frequency-domain data.

### Mathematical Foundation of the Hilbert Transform

The Hilbert transform is a fundamental mathematical operation that underpins the causality enforcement methods described above. The transform operates by applying a quadrature phase shift to frequency components: multiplication by −j for positive frequencies and by +j for negative frequencies, effectively rotating each frequency component by ±90 degrees.

The significance of the Hilbert transform in this context stems from its intimate connection to causality through the Kramers-Kronig relations. For any causal linear time-invariant system, these relations establish that:
The real and imaginary parts of the frequency response form a Hilbert transform pair.
The logarithmic magnitude and phase of a minimum-phase response form a Hilbert transform pair.

These mathematical relationships enable the reconstruction of complete frequency responses from partial data while guaranteeing causality. When a real signal f(t) is combined with its Hilbert transform to form the analytic signal f(t)+jH[f(t)], the resulting complex signal has a one-sided frequency spectrum, corresponding to a causal impulse response.

The correction methods presented in this invention exploit these fundamental relationships to ensure that the time-domain responses obtained from potentially incomplete or band-limited frequency data satisfy physical causality requirements. This mathematical framework provides the theoretical justification for the various reconstruction approaches, whether operating on real/imaginary parts or magnitude/phase components.

### Preservation of DC Component

A critical property of all correction methods presented herein is the preservation of the DC component (zero-frequency value) of the frequency response. The time-domain value at t=0 equals the average of the frequency-domain response across all sampled frequencies:

$$h [ 0 ] = ( 1 / N ) \cdot \sum H ( ω k )$$

Since the correction methods involve only phase adjustments or symmetric/antisymmetric decompositions without altering the overall magnitude spectrum, the DC component remains invariant. This preservation is essential for maintaining the correct steady-state behavior of the equivalent circuit model, as h[0] directly determines the resistance or conductance values in the final circuit representation. This invariance ensures parameter consistency across different correction methods and provides a valuable validation check for implementation correctness.

### Step 104: Constructing Equivalent Circuit Model

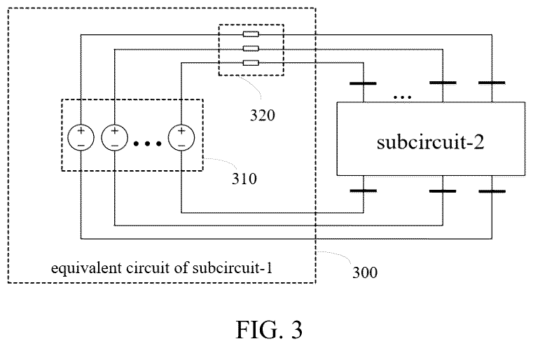

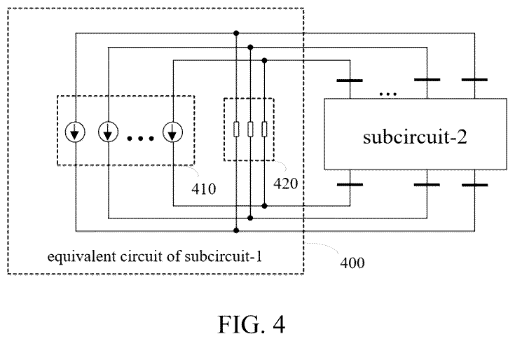

After obtaining the corrected system time-domain response, an equivalent circuit model can be constructed based on this response to replace subcircuit-1, enabling combination with subcircuit-2 to form a complete combined circuit for overall simulation. As shown in FIG. 3 and FIG. 4, this disclosure provides two specific forms of equivalent circuit models: a voltage source in series with a resistor (FIG. 3) and a current source in parallel with a conductor (FIG. 4). During simulation, these equivalent circuit models typically require real-time updating of their voltage source or current source values at each simulation time step, while the passive element parameters (such as resistance and conductance) in the models generally remain constant throughout the simulation process.

Depending on simulation requirements, the equivalent circuit model may adopt one of the following two specific forms, which are merely possible embodiments of this disclosure and do not limit the protection scope of this disclosure.

In a first possible embodiment, as shown in FIG. 3, subcircuit-1 is represented by equivalent circuit 300, which comprises voltage source 310 in series with resistor 320. Specifically, let the current simulation time step be n, the corrected system time-domain response sequence be h[k] (where k=0, 1, 2, . . . ), and the port current historical data be i[k], then the voltage value v[n] of voltage source 310 can be obtained through the following calculation:

$$v [ n ] = v\_oc [ n ] + \sum i [ k ] \times h [ n - k ]$$

where the summation is performed over all valid indices k from 0 to n−1, representing the discrete convolution between the port current history and the causal time-domain response. The open-circuit voltage v_oc[n] represents the contribution from internal sources within subcircuit-1 when no current flows through the port. For passive circuits without internal sources, v_oc[n]=0 for all n. The value R of resistor 320 depends on the value of the system time-domain response at zero time instant, i.e.: R=h[0]. This resistor maintains the DC characteristics of the equivalent model consistent with the actual circuit.

In a second possible embodiment, as shown in FIG. 4, subcircuit-1 is represented by equivalent circuit 400, which comprises current source 410 in parallel with conductor 420. Specifically, let the current simulation time step be n, the corrected system time-domain response sequence still be h[k] (where k=0, 1, 2, . . . ), and the port voltage historical data be v[k], then the current value i[n] of current source 410 can be obtained through the following calculation:

$$i [ n ] = i\_sc [ n ] + \sum v [ k ] \times h [ n - k ]$$

where the summation is performed over all valid indices k from 0 to n−1, representing the discrete convolution between the port voltage history and the causal time-domain response. The short-circuit current i_sc[n] represents the contribution from internal sources within subcircuit-1 when the port is short-circuited. For passive circuits without internal sources, i_sc[n]=0 for all n. The value G of conductor 420 depends on the value of the system time-domain response at zero time instant, i.e.: G=h[0]. This conductor maintains the DC characteristics of the model consistent with the actual circuit.

For subcircuit-1 containing P ports, the equivalent circuit model employs P voltage sources (or current sources) with P resistors (or conductors). The system behavior is characterized by:

For the voltage source model:

$$v [ n ] = v\_oc [ n ] + \sum H [ n - k ] \times i [ k ]$$

where v[n] and i[k] are P×1 vectors of port voltages and currents, v_oc[n] is a P×1 vector of open-circuit voltages, and H[k] is a P×P matrix of time-domain responses. The element H_ij[k] represents the voltage response at port i due to a unit current impulse at port j. The summation is performed over all valid indices k from 0 to n. The P×P resistance matrix R is given by R=H[0], where R_ij represents the coupling resistance between ports i and j.

For the current source model:

$$i [ n ] = i\_sc [ n ] + \sum H [ n - k ] \times v [ k ]$$

where i[n] and v[k] are P×1 vectors of port currents and voltages, i_sc[n] is a P×1 vector of short-circuit currents, and H[k] is a P×P matrix of time-domain responses. In this case, the element H_ij[k] represents the current response at port i due to a unit voltage impulse at port j. The P×P conductance matrix G is given by G=H[0], where G_ij represents the coupling conductance between ports i and j.

Sign conventions in circuit simulation depend on the chosen reference system. The following adjustments may be necessary:

For voltage sources: If the port current reference direction enters the subcircuit (following passive sign convention), the convolution term should be positive as shown. If the reference direction exits the subcircuit, multiply the convolution term by −1.

For current sources: Similar sign adjustments apply based on whether the voltage reference polarity follows the passive or active sign convention.

Implementation recommendation: Define port variables consistently with the simulation platform's conventions and adjust the equivalent source expressions accordingly.

In practical simulation, it should be particularly noted that at the initial simulation time steps (n<0), the convolution sum naturally truncates since h[k]=0 for k<0 due to causality. If non-zero initial conditions are required, they can be incorporated through the v_oc[n] or i_sc[n] terms for n>0, representing the circuit's initial energy storage state.

In some implementations, the corrected time-domain response may be optionally resampled to match the time discretization scheme used in the target simulation environment. This resampling ensures compatibility between the derived response data and the time-stepping framework adopted by downstream solvers. No limitation is imposed on the specific method or resolution of resampling, as it can be tailored to the characteristics of the simulation platform or application needs.

Additionally, it should be noted that after constructing the equivalent circuit model, some simple topological transformations may be performed on the circuit model according to requirements of actual simulation tools or application scenarios, such as converting a model with voltage source in series with resistor to a model with current source in parallel with conductor, or vice versa. Such topological structure transformations belong to basic equivalent transformations in circuit theory and do not fundamentally alter the modeling method proposed by this disclosure, nor do they exceed the protection scope of this disclosure.

### Step 105: Combining to Form Complete Circuit Model

After constructing the equivalent circuit model to replace subcircuit-1, this model must be connected with subcircuit-2 to form a complete combined circuit for system-level analysis. The core objective is to ensure voltage and current continuity at the connection interface, thereby achieving behaviorally equivalent integrated connection at the physical level.

Specifically, as shown in FIG. 3 and FIG. 4, the equivalent model of subcircuit-1 and subcircuit-2 are connected through ports. At each connection port k, the following conditions must be satisfied:

$$v\_port , k ( equivalent model ) = v\_port , k ( subcircuit - 2 )$$

$$i\_port , k ( equivalent model ) + i\_port , k ( subcircuit - 2 ) = 0$$

These conditions ensure Kirchhoff's voltage and current laws are satisfied at the interface, maintaining physical consistency throughout the simulation.

The combination can be implemented through various approaches depending on the characteristics of the target simulation platform. The disclosed method is compatible with both general-purpose and domain-specific simulation environments, and it can be adapted to different solver architectures without requiring changes to the underlying circuit formulation.

For multi-port systems with P ports, the connection process extends naturally, with voltage and current continuity enforced at each of the P ports. The P×P coupling matrices in the equivalent model properly represent the inter-port relationships, enabling accurate simulation of complex multi-node interactions in power systems, electromagnetic systems, or communication subsystems.

This disclosure encompasses any implementation approach that achieves proper port-level coupling between the equivalent circuit model and the remaining circuit, as the specific mechanism is a matter of software implementation rather than the fundamental modeling methodology.

### Step 106: Executing System Simulation and Obtaining Simulation Results

Once the combined circuit construction is complete, circuit simulation tools can be used to perform time-domain simulation on the combined overall system. During the simulation process, the constructed equivalent circuit model will be dynamically updated at each simulation time step based on current input conditions to accurately reflect the time-domain behavior of subcircuit-1.

Specifically, at each simulation time step n, the values of voltage sources or current sources in the equivalent circuit model will be updated based on convolution results between historical data of port variables (voltage or current) and the corrected system time-domain response. For voltage source models, the update follows:

$$v [ n ] = v\_oc [ n ] + \sum ( k = 0 to n - 1 ) i [ k ] \times h [ n - k ]$$

For current source models:

$$i [ n ] = i\_sc [ n ] + \sum ( k = 0 to n - 1 ) v [ k ] \times h [ n - k ]$$

where the summations represent discrete convolutions computed using the most recent port variable history. This update process ensures that the equivalent behavior of subcircuit-1 maintains consistent response relationships with the external system throughout the simulation period.

The updated combined circuit will be submitted to the time-domain numerical solver for overall circuit simulation analysis. Common time-domain numerical solution techniques include:
Trapezoidal integration: Offering good stability and second-order accuracy for general circuits
Backward Euler method: Providing unconditional stability for stiff systems
Gear's methods: Enabling variable-order integration for adaptive accuracy control
Newton-Raphson iteration: Solving nonlinear equations arising from nonlinear elements in subcircuit-2
Modified nodal analysis: Formulating system equations in a form suitable for direct matrix solution

These methods can be flexibly selected and combined according to specific simulation platforms, solver structures, and circuit scales to achieve efficient and accurate solution of system dynamic behavior.

Through the above solution process, major electrical response results of the combined circuit within the target time interval can be obtained, including port voltages, current waveforms, node voltage distributions, device current variations, and overall system dynamic characteristics. These simulation outputs can be used not only for circuit performance verification and behavior assessment but also provide fundamental data support for system-level design optimization, stability analysis, or protection strategy evaluation.

When adopting fixed time-step simulation strategies, the update period of the equivalent model strictly corresponds to the system time axis, and the constructed response can directly participate in convolution calculations. However, in practical engineering, especially when simulating large-scale circuit systems, rapidly changing processes, or multi-timescale coupled systems, variable time-step strategies are typically adopted to improve efficiency.

Variable time-step strategies require special handling of the convolution operation:
The historical data i[k] or v[k] must be maintained at the original fixed time points
Interpolation is applied when evaluating h[n−k] at non-grid points

The convolution sum may require adaptive quadrature for accurate integration between sample points

Resampling methods may be applied using standard numerical techniques to adjust the temporal resolution of the corrected response as needed. Such operations aim to align the data with simulation requirements while preserving the essential structure and physical meaning of the original time-domain response.

The equivalent model constructed by the method disclosed herein offers excellent port connectivity and system composability, enabling straightforward deployment across a broad range of simulation platforms—from SPICE-compatible and electromagnetic-transient tools to real-time and system-level environments—and remains readily extensible to proprietary frameworks, edge devices, and cloud-based simulation services.

The method described in this disclosure can be implemented in the form of computer programs or software modules. These computer programs can be stored on non-transitory computer-readable storage media, where such non-transitory computer-readable storage media include but are not limited to magnetic storage devices (such as hard drives), optical storage media (such as CD-ROM, DVD), flash memory devices (such as solid-state drives, USB drives), and other storage technologies that may be developed in the future. Computer systems executing said programs generally include but are not limited to processors (CPU), memory (RAM), permanent memory (ROM or hard drive), input/output interfaces, and peripheral devices connected thereto (such as keyboards, mice, displays, communication interfaces, etc.). Such computer systems can operate independently or networked to achieve higher computational capacity. It should be noted that the protection scope of this disclosure covers all computer programs, software modules capable of implementing said method, and computer hardware environments executing these programs or modules, without limitation to any specific hardware architecture or operating system environment.

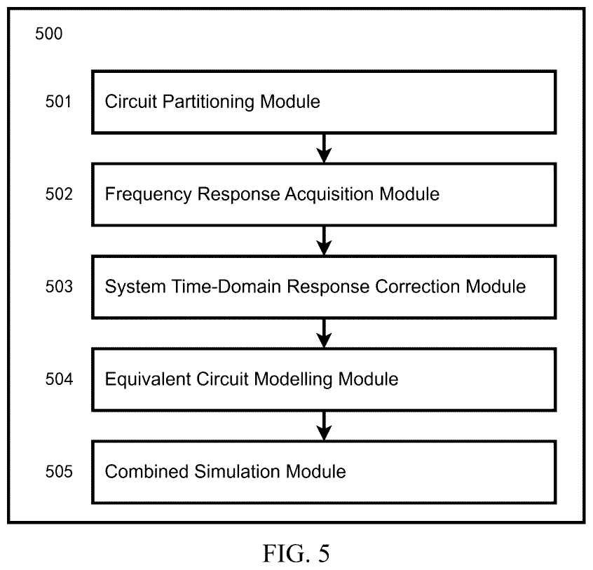

Referring to FIG. 5, shown is a structural schematic diagram of the simulation functional module system 500 of the method of this disclosure. The module system includes circuit partitioning module 501, frequency response acquisition module 502, system time-domain response correction module 503, equivalent circuit modeling module 504, and combination simulation module 505. Specifically:
Module 501 (Circuit Partitioning) identifies linear time-invariant portions suitable for frequency-domain characterization and determines the partition boundary
Module 502 (Frequency Response Acquisition) computes or measures transfer functions at discrete frequency points using analytical or numerical methods
Module 503 (Time-Domain Response Correction) applies causality-enforcing transformations using the methods described in Step 103
Module 504 (Equivalent Circuit Modeling) constructs voltage/current source models with convolution-based update mechanisms
Module 505 (Combination Simulation) integrates the equivalent model with subcircuit-2 and performs time-domain analysis

The modules are sequentially connected through data flow, with module 501 used for structural partitioning of the circuit to be simulated, its output results are then passed to module 502 to acquire frequency response, subsequently entering modules 503, 504, and 505 in sequence. In parallel implementations, modules 502-504 can process multiple ports concurrently, with synchronization required only at module boundaries. The convolution operations in module 505 are particularly amenable to parallel execution across frequency points or time windows. The module structure shown in FIG. 5 is one illustrative implementation of the disclosed method; specific implementation approaches can be flexibly adjusted according to actual system architecture, and the scope of the claimed subject matter is not limited by this partitioning.

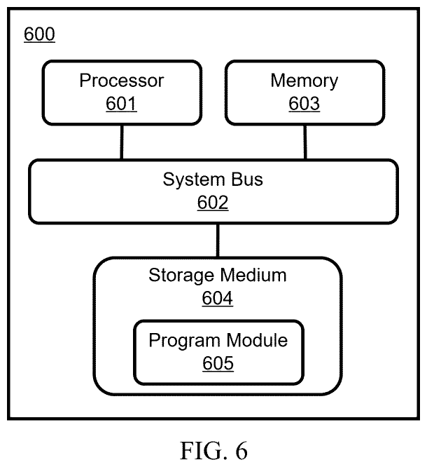

Referring to FIG. 6, a structural schematic of an implementation of the disclosed method in computer system 600 is shown. The computer system 600 can be a general-purpose computing device, server, embedded processor, industrial control device, edge computing platform, cloud simulation system, etc., possessing the capability to control, compute, and execute the disclosed method. The computer system 600 includes central processing unit 601, system bus 602, memory 603, storage medium 604, and program module 605. Central processing unit 601 typically includes one or more processing cores for loading and executing program instructions stored in storage medium 604, controlling the operation of various functional modules. System bus 602 is used for transmitting data and control information between central processing unit 601, memory 603, storage medium 604, and program module 605, achieving information interconnection between modules. Memory 603 is a high-speed, readable and writable storage device required for computer operation, typically including random access memory (RAM), used for temporarily storing intermediate data, parameter states, and computational cache during simulation processes, particularly the historical port variable arrays required for convolution calculations. Storage medium 604 is a non-transitory computer-readable storage device, including but not limited to hard drives, solid-state drives (SSD), flash memory devices, optical disks, magnetic tapes, etc., used for long-term storage of computer program code and required datasets for implementing the disclosed method. Program module 605 refers to executable software code stored in non-transitory computer-readable storage medium 604, used to implement the steps in the method described herein, including but not limited to circuit partitioning, frequency response processing, system response correction, equivalent modeling, and system simulation. Central processing unit 601 can invoke this program module to control and compute the combined circuit, achieving automated simulation of the entire process.

It should be understood that the structure shown in FIG. 6 is merely one illustrative implementation of the disclosed method and does not limit the scope of the claimed subject matter. The disclosed method can likewise be implemented on other software and hardware platforms with computing and storage functions, and can also run through cluster computing, cloud computing platforms, distributed systems, or edge node collaboration. The protection scope of the claimed subject matter is defined by the appended claims.

Those skilled in the art will recognize that the embodiments are provided to better explain the technical solution disclosed herein and are not intended to limit the scope defined by the claims. Without departing from the basic idea and spirit of the disclosed method, various modifications and variations can be made, such as using different data processing methods, model construction strategies, mathematical transformation techniques, numerical solution schemes, etc. These changes and variations, within the reasonable inference and understanding of those skilled in the art, should all be considered to fall within the protection scope determined by the appended claims of this disclosure. Specifically, the protection scope of this disclosure is limited only by the appended claims and their reasonable equivalent scope, and should not be limited by specific examples or descriptions in the specification.

### INDUSTRIAL APPLICABILITY

The disclosed method finds immediate application in industries requiring accurate circuit simulation, including power systems engineering for grid stability analysis, telecommunications for RF circuit design, and semiconductor manufacturing for high-speed digital interface verification. The platform-independent nature of the equivalent models enables seamless integration into existing design workflows across these industries.

1. A computer-implemented method for circuit simulation, comprising:
(a) partitioning a circuit to be simulated into a subcircuit-1 and a subcircuit-2, the subcircuit-1 being connected to the subcircuit-2 through at least one port;
(b) representing, for each sampled angular frequency ω, the port behavior of the subcircuit-1 as
(i) a complex impedance Z(ω) when the equivalent model in step (d)(i) is selected, or
(ii) a complex admittance Y(ω) when the equivalent model in step (d)(ii) is selected, and storing, for each ω, the real part Re{Z(ω)} (or Re{Y(ω)}) and the imaginary part Im{Z(ω)} (or Im{Y(ω)}) in machine-readable memory, the stored values being subsequently processed in step (c);
(c) applying one or more causality-enforcing correction methods to the frequency-domain response obtained in step (b), optionally in combination or in iterative stages, to generate a causal time-domain response;
(d) constructing an equivalent circuit model of the subcircuit-1 from the causal time-domain response, wherein the equivalent circuit model comprises one of:
(i) a series connection of a voltage source and a resistor, wherein the voltage source has a value equal to a convolution of port current with the causal time-domain response plus an open-circuit voltage contribution, and the resistor has a resistance equal to the causal time-domain response evaluated at time zero; or
(ii) a parallel connection of a current source and a conductor, wherein the current source has a value equal to a convolution of port voltage with the causal time-domain response plus a short-circuit current contribution, and the conductor has a conductance equal to the causal time-domain response evaluated at time zero;
(e) combining the equivalent circuit model with the subcircuit-2 by connecting corresponding ports while maintaining voltage and current continuity; and
(f) performing a time-domain simulation on the combined circuit.

2. The method of claim 1, wherein the causal time-domain response is obtained by:
extracting a real part of the frequency-domain response;
applying a Hilbert transform to the real part to generate a corresponding imaginary part;
combining the real part and the generated imaginary part to form a causal complex frequency-domain response; and
performing an inverse Fourier transform on the causal complex frequency-domain response to obtain the causal time-domain response.

3. The method of claim 1, wherein the causal time-domain response is obtained by:
transforming the real part of the frequency-domain response from frequency domain to time domain to obtain an initial time-domain response;
scaling a positive-time portion of the initial time-domain response by a predetermined factor;
setting a negative-time portion to zero;
preserving the value at time zero; and
using the resulting signal as the causal time-domain response.

4. The method of claim 1, wherein the causal time-domain response is obtained by:
performing an inverse Fourier transform on the frequency-domain response to obtain time-domain data;
for each positive-time instant, adding a value at that instant to a value at the corresponding negative-time instant to form a modified positive-time sequence;
setting the negative-time portion to zero;
preserving the value at time zero; and
using the resulting signal as the causal time-domain response.

5. The method of claim 1, wherein the causal time-domain response is obtained by:
extracting an imaginary part of the frequency-domain response;
applying a Hilbert transform to the imaginary part to generate a corresponding real part;
combining the generated real part and the imaginary part to form a causal complex frequency-domain response;
performing an inverse Fourier transform on the causal complex frequency-domain response to obtain an initial time-domain response;
assigning an average value of the original frequency-domain response to the value at time zero of the initial time-domain response; and
using the resulting signal as the causal time-domain response.

6. The method of claim 1, wherein the causal time-domain response is obtained by:
transforming the imaginary part of the frequency-domain response from frequency domain to time domain to obtain an initial time-domain response;
scaling a positive-time portion of the initial time-domain response by a predetermined factor;
setting a negative-time portion to zero;
assigning an average value of the original frequency-domain response to the value at time zero; and
using the resulting signal as the causal time-domain response.

7. The method of claim 1, wherein the causal time-domain response is obtained by:
performing an inverse Fourier transform on the frequency-domain response to obtain time-domain data;
for each positive-time instant, subtracting a value at the corresponding negative-time instant from a value at that instant to form a modified positive-time sequence;
setting the negative-time portion to zero;
preserving the value at time zero; and
using the resulting signal as the causal time-domain response.

8. The method of claim 1, wherein the causal time-domain response is obtained by:
extracting a magnitude of the frequency-domain response;
taking a natural logarithm of the magnitude to obtain a logarithmic magnitude;
applying a Hilbert transform to the logarithmic magnitude to generate a corresponding phase;
combining the original magnitude and the generated phase to form a minimum-phase frequency-domain response; and
performing an inverse Fourier transform on the minimum-phase frequency-domain response to obtain the causal time-domain response.

9. The method of claim 1, wherein the causal time-domain response is obtained by:
extracting a phase of the frequency-domain response;
applying a Hilbert transform to the phase to generate a corresponding logarithmic magnitude;
converting the logarithmic magnitude to a linear magnitude by exponentiation;
combining the linear magnitude with the original phase to form a causal complex frequency-domain response;
performing an inverse Fourier transform on the causal complex frequency-domain response to obtain an initial time-domain response;
assigning an average value of the original frequency-domain response to the value at time zero of the initial time-domain response; and
using the resulting signal as the causal time-domain response.

10. The method of claim 1, wherein performing the time-domain simulation comprises:
updating, at each simulation time step, the voltage of the voltage source or the current of the current source in the equivalent circuit model based on a convolution of historical port variables with the causal time-domain response;
solving the combined circuit using a time-domain numerical technique; and
obtaining at least one electrical response characteristic of the combined circuit within a predetermined time interval.

11. The method of claim 1, wherein:
the subcircuit-1 is connected to the subcircuit-2 through a plurality of ports;
the frequency-domain response comprises a matrix of transfer functions between the ports;
the causal time-domain response comprises a matrix of impulse responses; and
the equivalent circuit model comprises multiple voltage sources with a resistance matrix, or multiple current sources with a conductance matrix.

12. The method of claim 1, wherein the causality-enforcing correction in step (c) is performed using a combination of different correction techniques.

13. The method of claim 1, wherein the causality-enforcing correction in step (c) is applied iteratively to refine the corrected time-domain response.

14. The method of claim 1, further comprising:
resampling the causal time-domain response when a simulation time step differs from a sampling interval of the frequency-domain response, wherein the resampling maintains causality and preserves the value at time zero.

15. A non-transitory computer-readable storage medium storing instructions that, when executed by a processor, cause the processor to perform a method comprising:
(a) partitioning a circuit to be simulated into a subcircuit-1 and a subcircuit-2, the subcircuit-1 being connected to the subcircuit-2 through at least one port;
(b) representing, for each sampled angular frequency ω, the port behavior of the subcircuit-1 as
(i) a complex impedance Z(ω) when the equivalent model in step (d)(i) is selected, or
(ii) a complex admittance Y(ω) when the equivalent model in step (d)(ii) is selected, and storing, for each ω, the real part Re{Z(ω)} (or Re{Y(ω)}) and the imaginary part Im{Z(ω)} (or Im{Y(ω)}) in machine-readable memory, the stored values being subsequently processed in step (c);
(c) applying one or more causality-enforcing correction methods to the frequency-domain response obtained in step (b), optionally in combination or in iterative stages, to generate a causal time-domain response;
(d) constructing an equivalent circuit model of the subcircuit-1 from the causal time-domain response, wherein the equivalent circuit model comprises one of:
(i) a series connection of a voltage source and a resistor, wherein the voltage source has a value equal to a convolution of port current with the causal time-domain response plus an open-circuit voltage contribution, and the resistor has a resistance equal to the causal time-domain response evaluated at time zero; or
(ii) a parallel connection of a current source and a conductor, wherein the current source has a value equal to a convolution of port voltage with the causal time-domain response plus a short-circuit current contribution, and the conductor has a conductance equal to the causal time-domain response evaluated at time zero;
(e) combining the equivalent circuit model with the subcircuit-2 by connecting corresponding ports while maintaining voltage and current continuity; and
(f) performing a time-domain simulation on the combined circuit.

16. The non-transitory computer-readable storage medium of claim 15, wherein the causal time-domain response is obtained by:
extracting a real part of the frequency-domain response;
applying a Hilbert transform to the real part to generate a corresponding imaginary part;
combining the real part and the generated imaginary part to form a causal complex frequency-domain response; and
performing an inverse Fourier transform on the causal complex frequency-domain response to obtain the causal time-domain response.

17. The non-transitory computer-readable storage medium of claim 15, wherein the causal time-domain response is obtained by:
transforming the real part of the frequency-domain response from frequency domain to time domain to obtain an initial time-domain response;
scaling a positive-time portion of the initial time-domain response by a predetermined factor;
setting a negative-time portion to zero;
preserving the value at time zero; and
using the resulting signal as the causal time-domain response.

18. The non-transitory computer-readable storage medium of claim 15, wherein the causal time-domain response is obtained by:
performing an inverse Fourier transform on the frequency-domain response to obtain time-domain data;
for each positive-time instant, adding a value at that instant to a value at the corresponding negative-time instant to form a modified positive-time sequence;
setting the negative-time portion to zero;
preserving the value at time zero; and
using the resulting signal as the causal time-domain response.

19. The non-transitory computer-readable storage medium of claim 15, wherein the causal time-domain response is obtained by:
extracting an imaginary part of the frequency-domain response;
applying a Hilbert transform to the imaginary part to generate a corresponding real part;
combining the generated real part and the imaginary part to form a causal complex frequency-domain response;
performing an inverse Fourier transform on the causal complex frequency-domain response to obtain an initial time-domain response;
assigning an average value of the original frequency-domain response to the value at time zero of the initial time-domain response; and
using the resulting signal as the causal time-domain response.

20. The non-transitory computer-readable storage medium of claim 15, wherein the causal time-domain response is obtained by:
transforming the imaginary part of the frequency-domain response from frequency domain to time domain to obtain an initial time-domain response;
scaling a positive-time portion of the initial time-domain response by a predetermined factor;
setting a negative-time portion to zero;
assigning an average value of the original frequency-domain response to the value at time zero; and
using the resulting signal as the causal time-domain response.

21. The non-transitory computer-readable storage medium of claim 15, wherein the causal time-domain response is obtained by:
performing an inverse Fourier transform on the frequency-domain response to obtain time-domain data;
for each positive-time instant, subtracting a value at the corresponding negative-time instant from a value at that instant to form a modified positive-time sequence;
setting the negative-time portion to zero;
preserving the value at time zero; and
using the resulting signal as the causal time-domain response.

22. The non-transitory computer-readable storage medium of claim 15, wherein the causal time-domain response is obtained by:
extracting a magnitude of the frequency-domain response;
taking a natural logarithm of the magnitude to obtain a logarithmic magnitude;
applying a Hilbert transform to the logarithmic magnitude to generate a corresponding phase;
combining the original magnitude and the generated phase to form a minimum-phase frequency-domain response; and
performing an inverse Fourier transform on the minimum-phase frequency-domain response to obtain the causal time-domain response.

23. The non-transitory computer-readable storage medium of claim 15, wherein the causal time-domain response is obtained by:
extracting a phase of the frequency-domain response;
applying a Hilbert transform to the phase to generate a corresponding logarithmic magnitude;
converting the logarithmic magnitude to a linear magnitude by exponentiation;
combining the linear magnitude with the original phase to form a causal complex frequency-domain response;
performing an inverse Fourier transform on the causal complex frequency-domain response to obtain an initial time-domain response;
assigning an average value of the original frequency-domain response to the value at time zero of the initial time-domain response; and
using the resulting signal as the causal time-domain response.

24. The non-transitory computer-readable storage medium of claim 15, wherein performing the time-domain simulation comprises:
updating, at each simulation time step, the voltage of the voltage source or the current of the current source in the equivalent circuit model based on a convolution of historical port variables with the causal time-domain response;
solving the combined circuit using a time-domain numerical technique; and
obtaining at least one electrical response characteristic of the combined circuit within a predetermined time interval.

25. The non-transitory computer-readable storage medium of claim 15, wherein:
the subcircuit-1 is connected to the subcircuit-2 through a plurality of ports;
the frequency-domain response comprises a matrix of transfer functions between the ports;
the causal time-domain response comprises a matrix of impulse responses; and
the equivalent circuit model comprises multiple voltage sources with a resistance matrix, or multiple current sources with a conductance matrix.

26. The non-transitory computer-readable storage medium of claim 15, wherein the causality-enforcing correction in step (c) is performed using a combination of different correction techniques.

27. The non-transitory computer-readable storage medium of claim 15, wherein the causality-enforcing correction in step (c) is applied iteratively to refine the corrected time-domain response.

28. The non-transitory computer-readable storage medium of claim 15, further comprising:
resampling the causal time-domain response when a simulation time step differs from a sampling interval of the frequency-domain response, wherein the resampling maintains causality and preserves the value at time zero.

29. A circuit-simulation apparatus comprising a processor and a memory storing instructions that, when executed by the processor, cause the apparatus to perform a method comprising:
(a) partitioning a circuit to be simulated into a subcircuit-1 and a subcircuit-2, the subcircuit-1 being connected to the subcircuit-2 through at least one port;
(b) representing, for each sampled angular frequency ω, the port behavior of the subcircuit-1 as
(i) a complex impedance Z(ω) when the equivalent model in step (d)(i) is selected, or
(ii) a complex admittance Y(ω) when the equivalent model in step (d)(ii) is selected, and storing, for each o, the real part Re{Z(ω)} (or Re{Y(ω)}) and the imaginary part Im{Z(ω)} (or Im{Y(ω)}) in machine-readable memory, the stored values being subsequently processed in step (c);
(c) applying one or more causality-enforcing correction methods to the frequency-domain response obtained in step (b), optionally in combination or in iterative stages, to generate a causal time-domain response;
(d) constructing an equivalent circuit model of the subcircuit-1 from the causal time-domain response, wherein the equivalent circuit model comprises one of:
(i) a series connection of a voltage source and a resistor, wherein the voltage source has a value equal to a convolution of port current with the causal time-domain response plus an open-circuit voltage contribution, and the resistor has a resistance equal to the causal time-domain response evaluated at time zero; or
(ii) a parallel connection of a current source and a conductor, wherein the current source has a value equal to a convolution of port voltage with the causal time-domain response plus a short-circuit current contribution, and the conductor has a conductance equal to the causal time-domain response evaluated at time zero;
(e) combining the equivalent circuit model with the subcircuit-2 by connecting corresponding ports while maintaining voltage and current continuity; and
(f) performing a time-domain simulation on the combined circuit.

30. The circuit-simulation apparatus of claim 29, wherein the causal time-domain response is obtained by:
extracting a real part of the frequency-domain response;
applying a Hilbert transform to the real part to generate a corresponding imaginary part;
combining the real part and the generated imaginary part to form a causal complex frequency-domain response; and
performing an inverse Fourier transform on the causal complex frequency-domain response to obtain the causal time-domain response.

31. The circuit-simulation apparatus of claim 29, wherein the causal time-domain response is obtained by:
transforming the real part of the frequency-domain response from frequency domain to time domain to obtain an initial time-domain response;
scaling a positive-time portion of the initial time-domain response by a predetermined factor;
setting a negative-time portion to zero;
preserving the value at time zero; and
using the resulting signal as the causal time-domain response.

32. The circuit-simulation apparatus of claim 29, wherein the causal time-domain response is obtained by:
performing an inverse Fourier transform on the frequency-domain response to obtain time-domain data;
for each positive-time instant, adding a value at that instant to a value at the corresponding negative-time instant to form a modified positive-time sequence;
setting the negative-time portion to zero;
preserving the value at time zero; and
using the resulting signal as the causal time-domain response.

33. The circuit-simulation apparatus of claim 29, wherein the causal time-domain response is obtained by:
extracting an imaginary part of the frequency-domain response;
applying a Hilbert transform to the imaginary part to generate a corresponding real part;
combining the generated real part and the imaginary part to form a causal complex frequency-domain response;
performing an inverse Fourier transform on the causal complex frequency-domain response to obtain an initial time-domain response;
assigning an average value of the original frequency-domain response to the value at time zero of the initial time-domain response; and
using the resulting signal as the causal time-domain response.

34. The circuit-simulation apparatus of claim 29, wherein the causal time-domain response is obtained by:
transforming the imaginary part of the frequency-domain response from frequency domain to time domain to obtain an initial time-domain response;
scaling a positive-time portion of the initial time-domain response by a predetermined factor;
setting a negative-time portion to zero;
assigning an average value of the original frequency-domain response to the value at time zero; and
using the resulting signal as the causal time-domain response.

35. The circuit-simulation apparatus of claim 29, wherein the causal time-domain response is obtained by:
performing an inverse Fourier transform on the frequency-domain response to obtain time-domain data;
for each positive-time instant, subtracting a value at the corresponding negative-time instant from a value at that instant to form a modified positive-time sequence;
setting the negative-time portion to zero;
preserving the value at time zero; and
using the resulting signal as the causal time-domain response.

36. The circuit-simulation apparatus of claim 29, wherein the causal time-domain response is obtained by:
extracting a magnitude of the frequency-domain response;
taking a natural logarithm of the magnitude to obtain a logarithmic magnitude;
applying a Hilbert transform to the logarithmic magnitude to generate a corresponding phase;
combining the original magnitude and the generated phase to form a minimum-phase frequency-domain response; and
performing an inverse Fourier transform on the minimum-phase frequency-domain response to obtain the causal time-domain response.

37. The circuit-simulation apparatus of claim 29, wherein the causal time-domain response is obtained by:
extracting a phase of the frequency-domain response;
applying a Hilbert transform to the phase to generate a corresponding logarithmic magnitude;
converting the logarithmic magnitude to a linear magnitude by exponentiation;
combining the linear magnitude with the original phase to form a causal complex frequency-domain response;
performing an inverse Fourier transform on the causal complex frequency-domain response to obtain an initial time-domain response;
assigning an average value of the original frequency-domain response to the value at time zero of the initial time-domain response; and
using the resulting signal as the causal time-domain response.

38. The circuit-simulation apparatus of claim 29, wherein performing the time-domain simulation comprises:
updating, at each simulation time step, the voltage of the voltage source or the current of the current source in the equivalent circuit model based on a convolution of historical port variables with the causal time-domain response;
solving the combined circuit using a time-domain numerical technique; and
obtaining at least one electrical response characteristic of the combined circuit within a predetermined time interval.

39. The circuit-simulation apparatus of claim 29, wherein:
the subcircuit-1 is connected to the subcircuit-2 through a plurality of ports;
the frequency-domain response comprises a matrix of transfer functions between the ports;
the causal time-domain response comprises a matrix of impulse responses; and
the equivalent circuit model comprises multiple voltage sources with a resistance matrix, or multiple current sources with a conductance matrix.

40. The circuit-simulation apparatus of claim 29, wherein the causality-enforcing correction in step (c) is performed using a combination of different correction techniques.

41. The circuit-simulation apparatus of claim 29, wherein the causality-enforcing correction in step (c) is applied iteratively to refine the corrected time-domain response.

42. The circuit-simulation apparatus of claim 29, further comprising:
resampling the causal time-domain response when a simulation time step differs from a sampling interval of the frequency-domain response, wherein the resampling maintains causality and preserves the value at time zero.
